(19) United States
(12) Patent Application Publication
(10) Pub. No.: US 2009/0000196 A1
(43) Pub. Date: Jan. 1, 2009

(54) SYSTEMS AND METHODS FOR PREVENTING MOTOR VEHICLE DOORS FROM COMING INTO CONTACT WITH OBSTACLES

(75) Inventors: Craig A. Kollar, Sterling Heights, MI (US); Thomas A. Wilson, Rochester Hills, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GMGLOBAL TECHNOLOGY OPERATIONS, INC., DETROIT, MI (US)

(21) Appl. No.: 11/769,331

(22) Filed: Jun. 27, 2007

(51) Int. Cl. E05F 15/10; H02P 3/00

(52) U.S. Cl. 49/28; 318/468

(57) ABSTRACT

Systems and methods are provided for preventing a door from contacting an obstacle. One system includes a camera, a sensor, and a controller. The camera and the sensor are each configured to detect if the obstacle is within a path of the door. Another system includes an ultrasonic sensor, a near field sensor, and a controller. The ultrasonic sensor and the near field sensor are each configured to detect if the obstacle is within a path of the door. The controller in each system is configured to disable the door if the obstacle is detected within the path. One method includes the steps of visually or non-visually detecting if an obstacle is within an opening/closing path of a door when the obstacle is within or outside a camera field of view, respectively, and disabling the door if the obstacle is detected.

### TECHNICAL FIELD

The present invention generally relates to motor vehicles, and more particularly relates to systems and methods for preventing motor vehicle doors from coming into contact with obstacles.

### BACKGROUND OF THE INVENTION

Many motor vehicles have motorized systems for opening and/or closing one or more of the vehicle's doors. These motorized systems may include features that are intended to detect obstacles in the opening/closing path of the doors while the doors are being opened and/or closed. However, these systems detect the obstacle by actually coming into physical contact with the obstacle. For example, a sliding door on a van detects that a passenger is within its opening/closing path when the sliding door comes in contact with a passenger.

Accordingly, it is desirable to provide apparatus, systems, and methods for preventing an obstacle within an opening/closing path of a door of a motor vehicle from coming into contact with the door. It is also desirable to provide apparatus, systems, and methods for visually and/or non-visually detecting conductive and non-conductive obstacles within or outside the field of view of a visual feature. Furthermore, other desirable features and characteristics of the present invention will become apparent from the subsequent detailed description and the appended claims, taken in conjunction with the accompanying drawings and the foregoing technical field and background.

### SUMMARY OF THE INVENTION

Systems are provided for preventing an obstacle from coming into contact with a door of a motor vehicle. One system comprises a camera and a sensor coupled to the motor vehicle. The camera is configured to detect if the obstacle is within an opening/closing path of the door, and the sensor is also configured to detect if the obstacle is within the opening/closing path of the door. The system also comprises a controller coupled to the camera and the sensor, and the controller is configured to disable the door if the obstacle is detected within the opening/closing path.

Another system comprises an ultrasonic sensor and a near field sensor coupled to the motor vehicle. The ultrasonic sensor is configured to detect if the obstacle is within an opening/closing path of the door, and the near field sensor is also configured to detect if the obstacle is within the opening/closing path of the door. The system also comprises a controller coupled to the ultrasonic sensor and the near field sensor, and the controller is configured to disable the door if the obstacle is detected within the opening/closing path.

Methods are provided for preventing a motor vehicle door from coming into contact with an obstacle via a camera having a field of view and a sensor. One method comprises the steps of visually detecting if the obstacle is within an opening/closing path of the motor vehicle door when the obstacle is within the field of view of the camera and non-visually detecting if the obstacle is within the opening/closing path when the obstacle is outside the field of view of the camera. The method also comprises the step of automatically disabling the motor vehicle door if the obstacle is detected within the opening/closing path.

### DESCRIPTION OF THE DRAWINGS

The present invention will hereinafter be described in conjunction with the following drawing figures, wherein like numerals denote like elements, and

FIG. 1 is a block diagram of an exemplary embodiment of a system for preventing a motor vehicle door from coming into contact with an obstacle;

FIG. 2 is a block diagram of one embodiment of an apparatus for preventing a motor vehicle door from coming into contact with an obstacle included in the system of FIG. 1;

FIG. 3 is a block diagram of another embodiment of an apparatus for preventing a motor vehicle door from coming into contact with an obstacle included in the system of FIG. 1;

FIG. 4 is a schematic diagram of a side view and a rear view of a portion of a motor vehicle comprising the system of FIG. 1 coupled to a door; and

FIG. 5 is a flow diagram of one exemplary embodiment of a method for preventing a motor vehicle door from coming into contact with an obstacle.

### DESCRIPTION OF AN EXEMPLARY EMBODIMENT

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

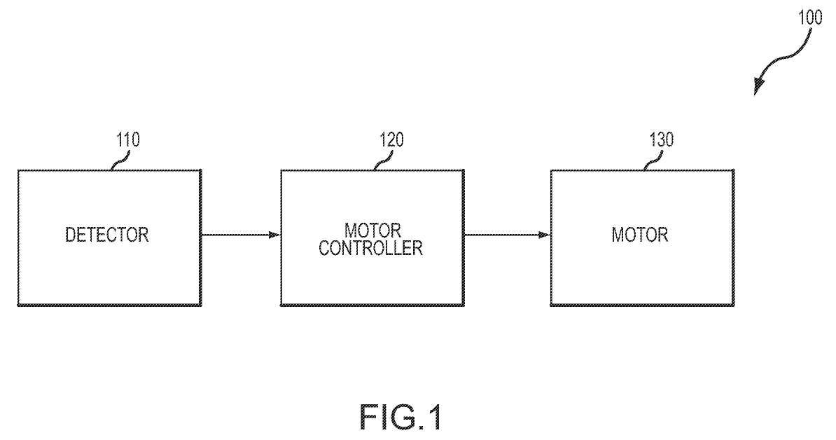

FIG. 1 is a block diagram of an exemplary embodiment of a system 100 for preventing a motor vehicle door from coming into contact with an obstacle (e.g., a pedestrian, another motor vehicle, a tree, a pole, a building, etc.). System 100 comprises a detector 110, a motor controller 120, and a motor 130 configured to open and/or close the motor vehicle door.

Detector 110 is coupled to motor controller 120, and is configured to monitor the environment surrounding detector 110 to detect the presence of an obstacle. Furthermore, detector 110 is configured to determine the distance the obstacle is away from one or more reference points (e.g., a motor vehicle door, a projected opening/closing path of the motor vehicle door, etc.) and determine if the obstacle is at and/or within a pre-determined threshold distance of the reference point. In various embodiments, the threshold distance is in the range of about 20 mm to about 200 mm. In one exemplary embodiment, the threshold distance is about 100 mm.

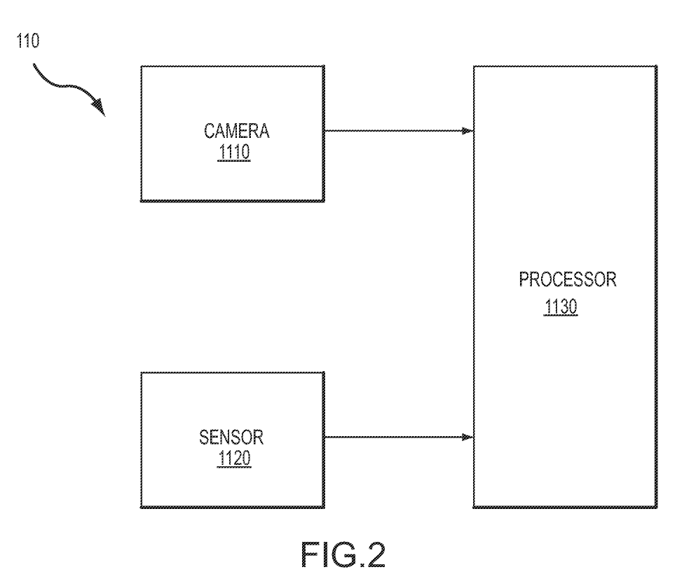

To determine if an obstacle is present, and if present, the distance the obstacle is away from the reference point, detector 110 comprises components (see FIG. 2) for visually and non-visually (e.g., electrically) monitoring the environment and detecting the presence of the obstacle. When detector 110 visually and/or non-visually detects that an obstacle is present and is at and/or within the threshold distance, detector 110 is configured to transmit a signal to motor controller 120 indicating such.

Motor controller 120 is configured, upon receiving the signal transmitted from detector 110, to command motor 130 to disable the door. In one embodiment, motor 130 disables the door by stopping the door when the door is in motion. In another embodiment, motor 130 disables the door by preventing the door from opening or closing when the door is at rest. In yet another embodiment, motor 130 disables the door by reversing the direction of the door. Specifically, if motor 130 is opening the door, motor 130 will disable the door by closing the door. Similarly, if motor 130 is closing the door, motor 130 disables the door by opening the door.

FIG. 2 is a block diagram of one exemplary embodiment of detector 110. Detector 110 comprises one or more cameras 1110, one or more sensors 1120, and one or more processors 1130.

Camera 1110 may be any device, hardware, software, and/or optical device capable of visually monitoring and detecting the presence of an obstacle. Camera 1110 is also configured to determine the distance the obstacle is away from camera 1110 and if the obstacle is within a pre-determined threshold distance of a reference point (e.g., a motor vehicle door). Specifically, camera 1110 is capable of monitoring an environment and determining how far an obstacle is away from the reference point using three-dimensional (3D) imaging and/or other visual distance-determining techniques. In accordance with one exemplary embodiment, camera 1110 is a 3D time-of-flight (TOF) camera.

Sensor 1120 may be any device, hardware, and/or software capable of non-visually (e.g., electrically) monitoring and detecting the presence of an obstacle. Furthermore, sensor 1120 is also configured to determine the distance the obstacle is away from sensor 1120 and if the obstacle is within a pre-determined threshold distance of a reference point. Sensor 1120 is configured to determine how far an obstacle is away from the reference point using capacitive sensing and/or other electrical distance-determining techniques. In one exemplary embodiment, sensor 1120 is a capacitive or near field sensor configured to form a capacitive element (e.g., a capacitor) when a conductive obstacle is at and/or within a threshold distance of sensor 1120.

Detector 110 also comprises a processor 1130 coupled to camera 1110 and sensor 1120. Processor 1130 is configured to receive signals from camera 1110 and sensor 1120 indicating that an obstacle is present in the environment, the distance the obstacle is away from the reference point, and/or if the obstacle is at and/or within the threshold distance of the reference point. Processor 1130 is also configured to process the signals from camera 1110 and sensor 1120, and selectively transmit a signal to motor controller 120 (see FIG. 1) when an obstacle is at and/or within the threshold distance of the reference point.

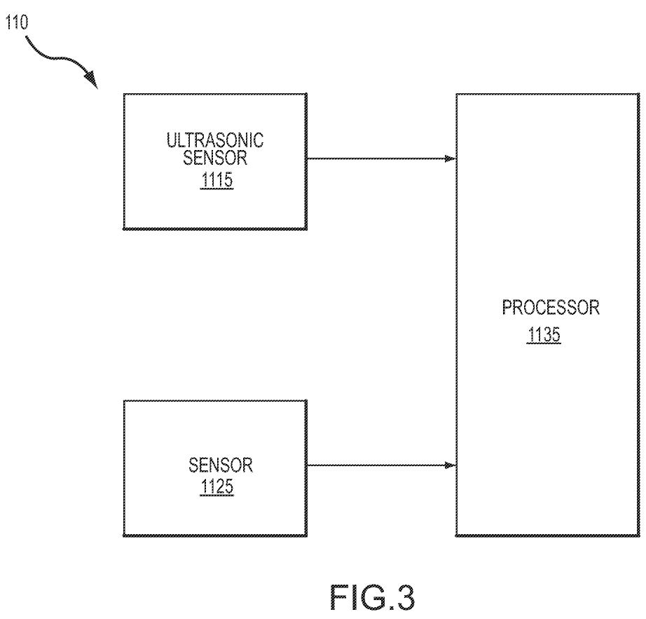

FIG. 3 is a block diagram of another exemplary embodiment of detector 110. Detector 110 comprises one or more ultrasonic sensors 1115, one or more sensors 1125, and one or more processors 1135.

Ultrasonic sensor 1115 may be any hardware, software, and/or device capable of sonically monitoring and detecting the presence of an obstacle. Ultrasonic sensor 1115 is also configured to determine the distance the obstacle is away from ultrasonic sensor 1115 and if the obstacle is within a pre-determined threshold distance of a reference point (e.g., a motor vehicle door). Specifically, ultrasonic sensor 1115 is capable of monitoring an environment and determining how far an obstacle is away from the reference point using sound waves, radio waves, and/or other similar distance-determining techniques. In accordance with one exemplary embodiment, ultrasonic sensor 1115 is a transducer that converts energy into sound waves.

Sensor 1125 may be any device, hardware, and/or software capable of non-visually (e.g., electrically) monitoring and detecting the presence of an obstacle. Furthermore, sensor 1125 is also configured to determine the distance the obstacle is away from sensor 1125 and if the obstacle is within a pre-determined threshold distance of a reference point. Sensor 1125 is configured to determine how far an obstacle is away from the reference point using capacitive sensing and/or other electrical distance-determining techniques. In one exemplary embodiment, sensor 1125 is a capacitive or near field sensor configured to form a capacitive element (e.g., a capacitor) when a conductive obstacle is at and/or within a threshold distance of sensor 1125.

Detector 110 also comprises a processor 1135 coupled to ultrasonic sensor 1115 and sensor 1125. Processor 1135 is configured to receive signals from ultrasonic sensor 1115 and sensor 1125 indicating that an obstacle is present in the environment, the distance the obstacle is away from the reference point, and/or if the obstacle is at and/or within the threshold distance of the reference point. Processor 1135 is also configured to process the signals from ultrasonic sensor 1115 and sensor 1125, and selectively transmit a signal to motor controller 120 (see FIG. 1) when an obstacle is at and/or within the threshold distance of the reference point.

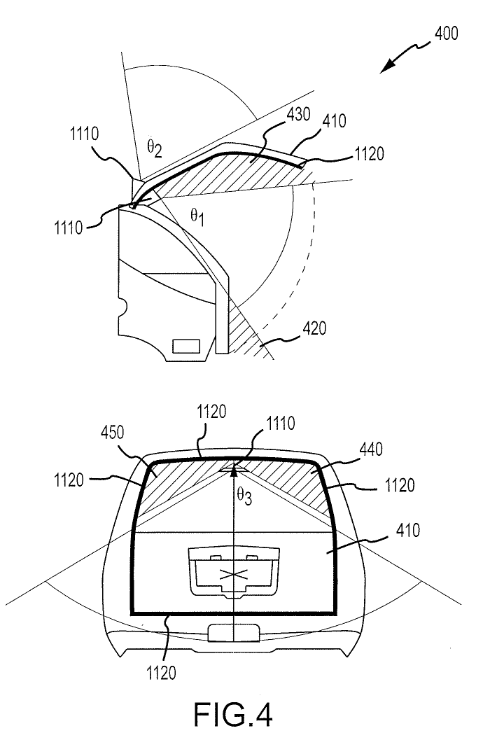

FIG. 4 is a schematic diagram of a side view and a rear view of a portion of a motor vehicle 400 comprising system 100 (see FIGS. 1 and 2) coupled to a door 410 of motor vehicle 400. As illustrated in FIG. 4, system 100 comprises two cameras 1110 and at least one sensor 1120 coupled to door 410, although motor vehicle 400 may include a greater number or a fewer number of cameras 1110 and sensors 1120.

In one exemplary embodiment, at least one camera 1110 is coupled to an interior portion of motor vehicle 400 and at least one other camera 1110 is coupled to an exterior portion of motor vehicle 400, although the interior or the exterior camera 1110 may be omitted. The exterior portion and/or interior portion of motor vehicle 400 may be portions of door 410 and/or other portions of motor vehicle 400 that enable cameras 1110 to perform their respective operations.

When door 410 is open, the camera 1110 coupled to the interior of motor vehicle 400 or door 410 is capable of visually detecting an obstacle in the area below door 410, as represented by the field of view θ₁. Similarly, the camera 1110 coupled to the exterior of motor vehicle 400 or door 410 is capable of visually detecting an obstacle in the area above door 410, as represented by the field of view θ₂. The field of views represented by θ₁ and θ₂ may each be angles in the range of about 40 degrees to about 90 degrees.

When door 410 is closed, the camera 1110 coupled to the exterior of motor vehicle 400 or door 410 is also capable of visually detecting an obstacle in the area behind door 410, as represented by the field of view θ₃. The field of views represented θ₃ may be an angle in the range of about 40 degrees to about 160 degrees.

In addition, cameras 1110 may also be configured to perform the functions of a back-up camera and/or a rear-park assistance camera. Furthermore, cameras 1110 may also be gesture-activated devices. Specifically, cameras 1110 may be configured to recognize various human body parts (e.g., head, hands, arms, etc.) and gestures (e.g., a “thumbs up,” a “thumbs down,” an “okay,” a “cut” sign, “stop” sign, etc.) and command (via motor controller 120) motor 130 to open, close, stop, reverse direction, etc. of a door.

At least one sensor 1120 is coupled to door 410. In one exemplary embodiment, sensor 1120 surrounds at least a portion of the interior and/or exterior perimeter of door 410 with respect to the interior/exterior of motor vehicle 400. Furthermore, sensor 1120 may be coupled to an exterior surface and/or within the interior of door 410 itself. Sensor 1120 may also substantially surround the entire perimeter of door 410.

In another exemplary embodiment, motor vehicle 400 comprises a plurality of sensors 1120 coupled to motor vehicle 400. In one embodiment, at least one sensor 1120 may be placed on and/or proximate each of the four lateral sides of door 410 so that obstacles in front of, behind, to the left of, to the right of, above, and/or below door 410 may be detected.

As illustrated in FIG. 4, there may be one or more areas (e.g., areas 420, 430, 440, and 450) where cameras 1110 are unable to visually detect obstacles. Obstacles within the threshold distance in these areas are, however, capable of being detected by sensor(s) 1120. For example, a person reaching an appendage into motor vehicle 400 while door 410 is closing may not be detected by cameras 1110 if the appendage is located in area 420; however, sensor(s) 1120 are able to detect the appendage in such circumstance. Furthermore, sensors 1120 may not be able to detect a non-conductive obstacle; however, cameras 1110 are able to visually detect the presence of a non-conductive obstacle. Accordingly, the combination of camera(s) 1110 and sensor(s) 1120 complement each other to detect the presence of obstacles so that door 410 does not come into contact with the obstacles.

Door 410 is illustrated in FIG. 4 as a liftgate; however, door 410 is not limited to a liftgate. That is, door 410 may be any type of door on motor vehicle 400 including, but not limited to, a sliding door on, for example, a van, a swinging door, a swing gate or a drop gate for a truck, a hatch for a hatchback vehicle, a side door (e.g., a front and rear side door), a hood, and the like.

Although FIG. 4 is discussed with reference to detector 110 of FIG. 2, one skilled in the art will appreciate that detector 110 of FIG. 3 may likewise be implemented in motor vehicle 400. That is, system 100 may be implemented on motor vehicle 400 to prevent door 410 from contacting an obstacle utilizing visual and non-visual techniques, as well as sonic and non-sonic techniques.

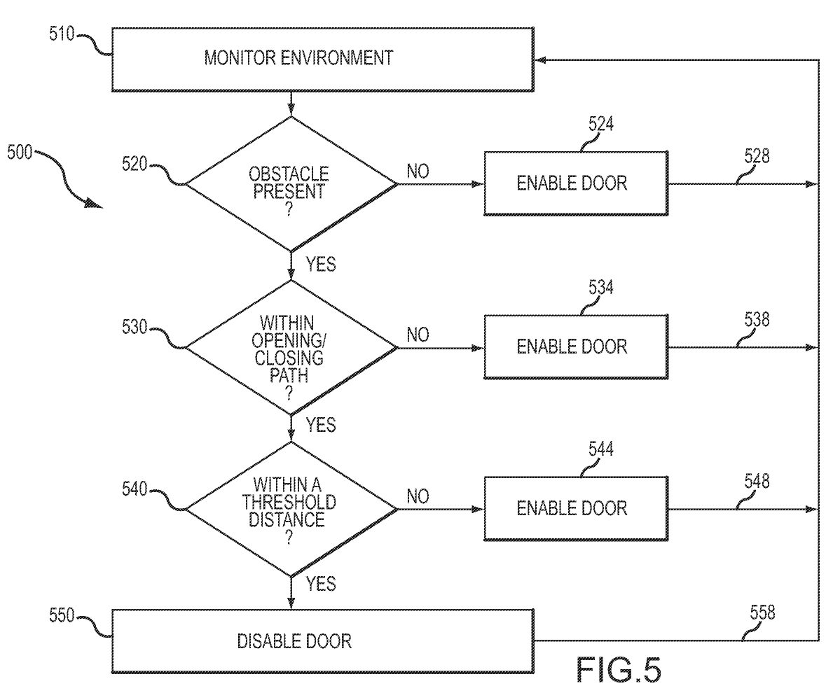

FIG. 5 is a flow diagram of one exemplary embodiment of a method 500 for preventing a motor vehicle door (e.g., door 410) from coming into contact with an obstacle. Method 500 begins by monitoring an environment (step 510) to determine if an obstacle is present proximate a door (e.g., door 410) of a motor vehicle (step 520). The environment may be continually, substantially continually, or periodically scanned by a detector (e.g., detector 110) while door 410 is in motion or when activated to begin opening/closing (via motor 130) door 410.

If an obstacle is not detected, door 410 is enabled (e.g., capable of being opened or closed) (step 524) and detector 110 continues monitoring the environment (step 528). Should detector 110 detect an obstacle, detector 110 determines if the obstacle is within an opening/closing path of door 410 (step 530).

If the obstacle is not within the opening/closing path of door 410, door 410 is enabled (step 534) and detector 110 continues monitoring the environment (step 538). If detector 110 detects that the obstacle is within the opening/closing path, detector 110 determines if the obstacle is within a threshold distance of door 410 (step 540).

If the obstacle is not within the threshold distance of door 410, door 410 is enabled (step 544) and detector 110 continues monitoring the environment (step 548). Should detector 110 detect that the obstacle is within the threshold distance, door 410 is disabled (step 550). Once disabled, the environment is again monitored to determine if the obstacle is still present (step 558).

Whether the obstacle is within the opening/closing path and the distance the obstacle is away from door 410 may be visually determined by one or more cameras (e.g., camera 1110) when the obstacle is within a field of view of camera(s) 1110. Furthermore, whether the obstacle is within the opening/closing path and the distance the obstacle is away from door 410 may be sonically determined by one or more ultrasonic sensors (e.g., ultrasonic sensors 1115) when the obstacle is within a range of ultrasonic sensor(s) 1115. Moreover, whether the obstacle is within the opening/closing path and the distance is away from door 410 may be non-visually (e.g., electrically, capacitively, etc.) or non-sonically determined by one or more sensors (e.g., sensors 1120 and 1125). That is, sensor(s) 1120 non-visually detect the obstacle when the obstacle is within and/or outside the field of view of camera(s) 1110. Similarly, sensor(s) 1125 non-visually detect the obstacle when the obstacle is within and/or outside the range of ultrasonic sensor(s) 1115.

The threshold distance may be in the range of about 20 mm to about 200 mm, although other distance ranges are contemplated by the invention. In one exemplary embodiment, the threshold distance is about 100 mm.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

We claim:

1. A system for preventing a motor vehicle door from coming into contact with an obstacle within an opening/closing path of the door, the system comprising:
a first camera coupled to the motor vehicle, the first camera configured to detect if the obstacle is within the opening/closing path;
a sensor coupled to the motor vehicle, the sensor configured to detect if the obstacle is within the opening/closing path; and
a controller coupled to the first camera and the sensor, the controller configured to disable the door if the obstacle is detected within the opening/closing path.

2. The system of claim 1, wherein the first camera is configured to detect the obstacle within a first portion of the opening/closing path and the sensor is configured to detect the obstacle within a second portion of the opening/closing path.

3. The system of claim 1, wherein the first camera is a three-dimensional time of flight (TOF) camera.

4. The system of claim 1, wherein the first camera is coupled to an exterior portion of the door.

5. The system of claim 4, further comprising a second camera coupled to an interior portion of the door and in communication with the controller, wherein one of the first and second cameras are a 3-dimensional TOF camera.

6. The system of claim 1, wherein the controller is further configured to disable the door if the obstacle is detected within a threshold distance of the opening/closing path.

7. The system of claim 1, wherein the sensor is a near field sensor.

8. The system of claim 7, wherein the near field sensor surrounds at least a portion of a perimeter of the door.

9. The system of claim 1, wherein the sensor is a second camera.

10. The system of claim 1, wherein the first camera is a three-dimensional time of flight (TOF) camera and the sensor is a near field sensor.

11. The system of claim 1, wherein the door is one of a liftgate, a sliding door, a front side door, and a rear side door.

12. A system for preventing a motor vehicle door from coming into contact with an obstacle within an opening/closing path of the door, the system comprising:
a first ultrasonic sensor coupled to the motor vehicle, the first ultrasonic sensor configured to detect if the obstacle is within the opening/closing path;
a near field sensor coupled to the door, the near field sensor configured to detect if the obstacle is within the opening/closing path; and
a controller coupled to the first ultrasonic sensor and the near field sensor, the controller configured to disable the door if the obstacle is detected within the opening/closing path.

13. The system of claim 12, further comprising a second ultrasonic sensor coupled to the controller, the second ultrasonic sensor configured to determine if the obstacle is within the closing/opening path.

14. The system of claim 12, wherein the near field sensor surrounds at least a portion of a perimeter of the door.

15. The system of claim 12, wherein the controller is further configured to disable the door if the obstacle is detected within a threshold distance of the opening/closing path.

16. A method for preventing a motor vehicle door having an opening/closing path from contacting an obstacle via a camera having a field of view and a sensor, comprising the steps of:
visually detecting if the obstacle is within the opening/closing path when the obstacle is within the field of view;
non-visually detecting if the obstacle is within the opening/closing path when the obstacle is outside the field of view; and
automatically disabling the motor vehicle door if the obstacle is detected within the opening/closing path.

17. The method of claim 16, wherein the motor vehicle door is disabled when the motor vehicle door is within a threshold distance of the obstacle.

18. The method of claim 17, wherein the threshold distance is in the range of about 20 mm to about 200 mm.

19. The method of claim 16, wherein the non-visually detecting step comprises capacitively detecting if the obstacle is within the threshold distance.

20. The method of claim 16, wherein the visually detecting step comprises the step of using three-dimensional imaging to determine if the obstacle is with the opening/closing path.
